(19) United States
(12) Patent Application Publication
(10) Pub. No.: US 2025/0179374 A1
(43) Pub. Date: Jun. 5, 2025

(54) FLUID CATALYTIC CRACKING PROCESS

(71) Applicant: Ketjen Limited Liability Company, Houston, TX (US)

(72) Inventors: Geroge Yaluris, Houston, TX (US); James Strohm, League City, TX (US); Oscar Oyola-Rivera, Pearland, TX (US)

(73) Assignee: Ketjen Limited Liability Company, Houston, TX (US)

(21) Appl. No.: 18/843,022

(22) PCT Filed: Mar. 10, 2023
(86) PCT No.: PCT/US2023/014997

§ 371 Date: Aug. 30, 2024

Related U.S. Application Data
(60) Provisional application No. 63/319,173, filed on Mar. 11, 2022.

(51) Int. Cl. C10G 11/05; B01J 23/10; B01J 29/08; B01J 29/40; B01J 29/80

(52) U.S. Cl. CPC C10G 11/05; B01J 23/10; B01J 29/088; B01J 29/40; B01J 29/80; B01J 2523/31; B01J 2523/36; B01J 2523/3706; B01J 2523/3712; B01J 2523/3718; B01J 2523/41; B01J 2523/51; C10G 2300/1014

(57) ABSTRACT

This invention provides a process for fluid catalytic cracking of a feedstock, which process comprises contacting a fluid catalytic cracking catalyst composition with a feedstock comprising an oxygenated feed and optionally a hydrocarbon feed, wherein the oxygenated feed comprises at least one oxygenated compound containing at least carbon, hydrogen, and oxygen.

### TECHNICAL FIELD

This invention relates to processes for fluid catalytic cracking of feedstocks comprising one or more oxygenated compounds optionally with a hydrocarbon feed as a part of the feedstock.

### BACKGROUND

Fluid catalytic cracking unit (FCCU) constraints related to the formation of coke and hydrogen are known problems in the fluid catalytic cracking of hydrocarbon feedstocks. Various methods for reduction of coke and hydrogen have been attempted, such as inclusion of small amounts of additives with the fluid catalytic cracking catalyst, modification of the active ingredients forming the fluid catalytic cracking catalyst, minimizing the use of hydrocarbon feedstocks that have a reduced carbon residue or a reduced amount of metal contaminants, and altering operational parameters such as feedstock throughput and reaction temperatures. Further improvements in coke reduction and hydrogen reduction from fluid catalytic cracking processes are desirable.

### SUMMARY OF THE INVENTION

This invention provides processes for catalytic cracking of feedstocks comprising one or more oxygenated compounds, optionally and preferably with a hydrocarbon feed as a part of the feedstock. The processes of this invention typically produce less coke and decrease hydrogen production. Additional advantages provided by the processes of this invention may include one or more of: decreased bottoms, decreased LCO (light cycle oil) yield, improved gasoline yield, improved propylene yield, increased naphtha yield, and increased olefinicity. In at least some embodiments, the benefits obtained, especially the reduction in coke and hydrogen, are greater than can be attributed to dilution effects and/or additive effects from the oxygenated compound(s).

An embodiment of this invention is fluid catalytic cracking process which comprises contacting a fluid catalytic cracking catalyst composition with a feedstock comprising an oxygenated feed and optionally a hydrocarbon feed. The oxygenated feed comprises at least one oxygenated compound containing at least carbon, hydrogen, and oxygen. The fluid catalytic cracking catalyst composition comprises one or more Y-type zeolites, one or more ZSM-5 zeolites, a rare earth component, a phosphorus component, and alumina comprising boehmite and/or pseudoboehmite. Alternatively, the fluid catalytic cracking catalyst composition comprises one or more Y-type zeolites, a rare earth component, a phosphorus component, and alumina comprising boehmite and/or pseudoboehmite.

Another embodiment of this invention is a fluid catalytic cracking catalyst composition comprising one or more Y-type zeolites, one or more ZSM-5 zeolites, a rare earth component, and alumina comprising boehmite and/or pseudoboehmite; alternatively, the fluid catalytic cracking catalyst composition comprises one or more Y-type zeolites, a rare earth component, and alumina comprising boehmite and/or pseudoboehmite.

These and other embodiments and features of this invention will be still further apparent from the ensuing description and appended claims.

### BRIEF DESCRIPTION OF THE DRAWINGS

FIG. 1 is a graph comparing predicted and actual hydrogen and coke yields for comparative Catalyst A of Example 1.

FIG. 2 is a graph of comparing predicted and actual hydrogen and coke yields for Catalyst B of Example 1.

The Figures illustrate embodiments of specific aspects of the invention, and are not intended to impose limitations on the scope of the invention.

### FURTHER DETAILED DESCRIPTION OF THE INVENTION

The terms “ZSM-5” and “ZSM-5 zeolite” are used interchangeably throughout this document.

As used throughout this document, the phrase “fluid catalytic cracking composition” is used interchangeably with the phrase “catalyst composition.”

Throughout this document, amounts for catalysts, catalyst additives, and components thereof are reported for the dried materials, or relative to the other dry ingredients or components of the catalyst or catalyst additive, unless otherwise specified.

As used throughout this document, the phrase “expressed as its oxide” and analogous phrases for rare earths and phosphorus refer to the amount of rare earth element or phosphorus, where the numerical value is for the respective oxide(s) of the rare earth element(s) or, for phosphorus, for phosphorus pentoxide (P₂O₅). When more than one rare earth element is present, the amount refers to the total of all of the rare earth elements present as their oxides, unless otherwise indicated.

In some embodiments, the fluid cracking catalyst compositions used in the processes of the invention contain components comprising one or more Y-type zeolites, one or more ZSM-5 zeolites, a rare earth component, alumina comprising boehmite and/or pseudoboehmite, optionally phosphorus, optionally silica, and optionally clay. In other embodiments, the fluid cracking catalyst compositions used in the processes of the invention contain components comprising one or more Y-type zeolites, a rare earth component, alumina comprising boehmite and/or pseudoboehmite, optionally phosphorus, optionally silica, and optionally clay. Other optional ingredients can be present in the fluid cracking catalyst compositions used in the practice of this invention.

In the fluid cracking catalysts, the dry ingredients that form the catalyst composition include zeolites, alumina, optional phosphorus component, optional silica component, optional clay component, and any other dry ingredients that are used to make the catalyst composition and remain in the catalyst composition.

Y-type zeolites are large pore zeolites. Suitable Y-type zeolites in the practice of this invention include Y zeolite, ultrastable Y zeolite (USY), HY zeolite, and dealuminated Y zeolite. In some embodiments, preferred Y-type zeolites include ultrastable Y zeolite and Y zeolite.

In the fluid cracking catalyst compositions that include a ZSM-5 zeolite, the Y-type zeolite is typically present in an amount in the catalyst composition of about 0.5 wt % or more relative to the total weight of the catalyst composition. In some embodiments, amounts of the Y-type zeolite in the catalyst compositions that include a ZSM-5 zeolite are about 2.5 wt % or more, preferably about 5 wt % or more, relative to the total weight of the catalyst composition. Typically, in the catalyst compositions that include a ZSM-5 zeolite, the Y-type zeolite is present in an amount of about 0.5 wt % to about 50 wt %, preferably about 2.5 wt % to about 45 wt %, more preferably about 5 wt % to about 40 wt %, relative to the total weight of the catalyst composition.

In the fluid cracking catalyst compositions that do not include a ZSM-5 zeolite, the Y-type zeolite is typically present in an amount in the catalyst composition of about 5 wt % or more relative to the total weight of the catalyst composition. In some embodiments, preferred amounts of the Y-type zeolite in the catalyst compositions that do not include a ZSM-5 zeolite are about 7.5 wt % or more, especially about 10 wt % or more, relative to the total weight of the catalyst composition. Typically, in the catalyst compositions that do not include a ZSM-5 zeolite, the Y-type zeolite is present in an amount of about 5 wt % to about 60 wt %, preferably about 7.5 wt % to about 55 wt %, more preferably about 10 wt % to about 55 wt %, relative to the total weight of the catalyst composition.

Pentasil zeolites are small or medium pore zeolites. ZSM-5 zeolites are pentasil zeolites, and are used in the practice of this invention.

In some embodiments in which the fluid cracking catalyst compositions include a ZSM-5 zeolite, the ZSM-5 zeolite is typically present in an amount in the catalyst composition of about 1 wt % or more, preferably about 2 wt % or more preferably about 5 wt % or more, relative to the total weight of the catalyst composition. Typically, in the catalyst compositions that include a ZSM-5 zeolite, the ZSM-5 zeolite is present in an amount of about 1 wt % to about 50 wt %, preferably about 2 wt % to about 45 wt %, more preferably about 5 wt % to about 40 wt %, relative to the total weight of the catalyst composition.

In other embodiments in which the fluid cracking catalyst compositions include a ZSM-5 zeolite, the ZSM-5 zeolite is typically present in an amount in the catalyst composition of about 2.5 wt % or more, preferably about 5 wt % or more, relative to the total weight of the catalyst composition. In some preferred embodiments, the ZSM-5 zeolite is present in an amount of about 2.5 wt % to about 50 wt %, preferably about 5 wt % to about 45 wt %, more preferably about 5 wt % to about 40 wt %, relative to the total weight of the catalyst composition.

In yet other embodiments in which the fluid cracking catalyst compositions include a ZSM-5 zeolite, the ZSM-5 zeolite is typically present in an amount in the catalyst composition of about 15 wt % or more, often about 15 wt % to about 50 wt %, preferably about 15 wt % to about 45 wt %, more preferably about 15 wt % to about 40 wt %, relative to the total weight of the catalyst composition.

In the fluid cracking catalyst compositions that include a ZSM-5 zeolite, the Y-type zeolite and the ZSM-5 zeolite are present in a combined amount of about 15 wt % or more, preferably about 20 wt % or more, more preferably about 25 wt % or more, relative to the total weight of the catalyst composition. In some embodiments, the Y-type zeolite and the ZSM-5 zeolite are present in a combined amount of about 15 wt % to about 75 wt %, preferably about 20 wt % to about 60 wt %, more preferably about 25 wt % to about 50 wt %, relative to the total weight of the catalyst composition.

In the fluid cracking catalyst compositions that include a ZSM-5 zeolite, the weight ratio of the Y-type zeolite to the ZSM-5 zeolite is about 0.25:1 or more, preferably about 0.3:1 or more. In some embodiments, the weight ratio of the Y-type zeolite to the ZSM-5 zeolite is about 0.25:1 to about 2.75:1; in other embodiments, the weight ratio of the Y-type zeolite to the ZSM-5 zeolite is about 0.3:1 to about 2.5:1, preferably about 0.3:1 to about 1.5:1.

In other embodiments in which the fluid cracking catalyst compositions include a ZSM-5 zeolite, the weight ratio of the Y-type zeolite to the ZSM-5 zeolite is about 1.5:1 or more, preferably about 2:1 or more. In some embodiments, the weight ratio of the Y-type zeolite to the ZSM-5 zeolite is about 1.5:1 to about 8:1; in other embodiments, the weight ratio of the Y-type zeolite to the ZSM-5 zeolite is about 2:1 to about 8:1.

Other large pore zeolites and/or other small or medium pore zeolites can be present in the fluid cracking catalyst compositions in the practice of this invention. Large pore zeolites have a 12-membered or larger ring structure in the zeolite framework. In small or medium pore zeolites, the largest ring structure in the zeolite framework is smaller than a 12-membered ring. Some zeolites have features that result in their classification as both large pore and small or medium pore zeolites; these zeolites can be used in this invention.

Suitable other large pore zeolites that can be part of the fluid cracking catalyst composition include faujasite, beta zeolite, mordenite, X zeolites, AFI, AFR, BEC, BOG, EMT, EON, ETR, EWT, IFT, IFU, IRR, ISV, IWR, IWS, IWW, LTL, MEI, MOR, MOZ, MSE, OFF, SSZ-31, and/or SSZ-60. Any of these large pore zeolites that are rare earth-containing can also be used.

Suitable other small or medium pore zeolites that can be part of the fluid cracking catalyst composition include ZSM-4, ZSM-11, ZSM-12, ZSM-18, ZSM-20, ZSM-22, ZSM-23, ZSM-35, ZSM-38, ZSM-48, ZSM-50, ZSM-57, beta zeolite, chabazite, mazzite, mordenite, natrolite, offretite, stilbite, Li-A zeolite, zeolite Na-P1, zeolite Na-P2, zeolite A, zeolite L, zeolite Q (or zeolite KI or Linde Q), zeolite T, zeolite RHO, AIPO-18, CIT-5, CIT-7, ECR-1, EMC-2, EMM-10, EMM-26, EU-1, IPC-4, IM-5, MCM-22, MCM-35, MCM-36, MCM-49, MCM-56, MCM-58, MCM-68, NU-87, SSZ-13, SSZ-23, SSZ-35, SSZ-36, SSZ-48, SSZ-61, SUZ-4, TNU-9, UZM-4, UZM-8, ITQ zeolites such as ITQ-2, ITQ-3, ITQ-4, ITQ-7, ITQ-12, ITQ-13, ITQ-30, ITQ-39, and ITQ-51, silicoaluminophosphate zeolites (SAPOs) such as SAPO-5, SAPO-11, SAPO-18, SAPO-31, SAPO-34, and SAPO-41, and aluminophosphate zeolites (ALPOs). Two or more small or medium pore zeolites can be used. Preferred small or medium pore zeolites include pentasil zeolites; preferred pentasil zeolites include beta zeolite, IM-5, ZSM-11, ZSM-12, ZSM-22, ZSM-23, and ZSM-57.

The fluid cracking catalyst compositions used in the practice of this invention comprise a rare earth component. The rare earth elements can be yttrium or any of the lanthanide series, including lanthanum, cerium, praseodymium, neodymium, promethium, samarium, europium, gadolinium, terbium, dysprosium, holmium, erbium, thulium, and ytterbium. In some embodiments, the rare earth elements can be yttrium, lanthanum, cerium and/or praseodymium, preferably lanthanum and/or cerium; often, lanthanum is more preferred.

In some embodiments, the rare earth component is present in the fluid cracking catalyst composition in an amount of about 0.25 wt % or more, preferably about 0.5 wt % or more, expressed as rare earth oxides(s), relative to the total weight of the catalyst composition. In other embodiments, the rare earth component is present in the catalyst composition in an amount of about 0.25 wt % to about 20 wt %, expressed as rare earth oxides(s), relative to the total weight of the catalyst composition. In other embodiments, the rare earth component is present in an amount of about 0.5 wt % to about 15 wt %, preferably about 0.5 wt % to about 10 wt %, more preferably about 0.5 wt % to about 7.5 wt %, expressed as rare earth oxides(s), relative to the total weight of the catalyst composition. The rare earth element oxides are their common oxides, e.g. La₂O₃ for lanthanum and CeO₂ for cerium. When more than one rare earth element is present in the catalyst composition, the amount of the rare earth component in the catalyst composition is the total of the individual rare earth oxide amounts.

In some embodiments, the rare earth component is present in the Y-type zeolite before combination with other catalyst components. When the rare earth component is present in the Y-type zeolite, the rare earth element may be incorporated into the Y-type zeolite by any convenient method, for example via ion exchange into the Y-type zeolite or by impregnation into the Y-type zeolite.

In embodiments in which the rare earth component is present in the catalyst composition outside of the Y-type zeolite, the rare earth component can be introduced at any convenient point during preparation of the catalyst composition, e.g., when combining one or more components, or after the other catalyst components have been combined.

In other embodiments, a portion of the rare earth component is present in the Y-type zeolite before combination with other catalyst components and a portion of the rare earth component is present in the catalyst composition outside of the Y-type zeolite.

In some embodiments, in which an optional phosphorus component is present in the fluid cracking catalyst composition, the phosphorus is present in an amount of about 0.1 wt % or more, preferably about 0.2 wt % or more, expressed as phosphorus pentoxide, relative to the total weight of the catalyst composition. In other embodiments in which phosphorus is present, the phosphorus component is present in an amount of about 0.1 wt % to about 10 wt %, preferably about 0.1 wt % to about 7.5 wt %, more preferably about 0.2 wt % to about 7.5 wt %, still more preferably about 0.2 wt % to about 5 wt %, expressed as phosphorus pentoxide, relative to the total weight of the catalyst composition.

In some embodiments in which the fluid cracking catalyst compositions include a ZSM-5 zeolite and phosphorus is present, the phosphorus component is present in the ZSM-5 zeolite before combination with other catalyst components. When an optional phosphorus component is present in the ZSM-5 zeolite, the phosphorus component may be incorporated into the ZSM-5 zeolite by any convenient method, for example by impregnation into the ZSM-5 zeolite.

In embodiments in which an optional phosphorus component is present in the catalyst composition outside of the ZSM-5 zeolite for fluid cracking catalyst compositions include a ZSM-5 zeolite, the phosphorus component can be introduced at any convenient point during preparation of the catalyst composition, e.g., when combining one or more components, or after the other catalyst components have been combined.

In other embodiments, a portion of an optional phosphorus component is present in the ZSM-5 zeolite before combination with other catalyst components and a portion of an optional phosphorus component is present in the catalyst composition outside of the ZSM-5 zeolite.

For introduction of a phosphorus component, suitable phosphorus sources include phosphoric acid, pyrophosphoric acids, polyphosphoric acids, hypophosphoric acid, hypophosphorous acid, ammonium phosphates, phosphorus oxides such as phosphorus pentoxide, and phosphate salts, such as metal phosphates. When the fluid cracking catalyst compositions include a ZSM-5 zeolite, commercially available phosphorus-containing ZSM-5 zeolites can also be used in the practice of this invention.

In some embodiments, all of the components of the fluid cracking catalyst composition are present in a single particle. In other embodiments, the components of the fluid cracking catalyst composition are present in more than one particle, sometimes in two or more particles, preferably in two particles. The zeolites can be in the same particle or distributed in separate particles; when distributed in separate particles, the separate particles can contain the same zeolite(s) and/or different zeolites.

In some embodiments in which the fluid cracking catalyst compositions include a ZSM-5 zeolite, the Y-type zeolite and at least a portion of the rare earth component are present in one particle and the ZSM-5 zeolite is present in another particle. When present, at least a portion of the optional phosphorus component is present in the particle containing the ZSM-5 zeolite. Normally, a portion of the alumina is present in each particle.

In other embodiments in which the fluid cracking catalyst compositions include a ZSM-5 zeolite, the components of the catalyst composition can be distributed across particles with a portion of one or both of the Y-type zeolite and the ZSM-5 zeolite in more than one particle. Suitable distributions include all of the Y-type zeolite and a portion of the ZSM-5 zeolite in one particle, and the remaining portion of the ZSM-5 zeolite in another particle; and all of the ZSM-5 zeolite and a portion of the Y-type zeolite in one particle, and the remaining portion of the Y-type zeolite in another particle. In these embodiments in which the catalyst composition is distributed across particles with a portion of one or both of the Y-type zeolite and the ZSM-5 zeolite in more than one particle, portions of the alumina are present in each particle; at least a portion of the rare earth component is present with at least a portion of the Y-type zeolite. In preferred embodiments, when phosphorus is present, at least a portion of the optional phosphorus component is present with at least a portion of the ZSM-5 zeolite.

The alumina in the fluid cracking catalyst composition is in the form of boehmite and/or pseudoboehmite. Boehmite and pseudoboehmite can be in microcrystalline form or in crystalline form. Preferably, the alumina comprises boehmite or comprises boehmite and pseudoboehmite. Preferably, the boehmite is crystalline or microcrystalline and the pseudoboehmite is microcrystalline. More preferably, the alumina comprises boehmite or comprises boehmite and pseudoboehmite and the boehmite is crystalline or microcrystalline and the pseudoboehmite is microcrystalline.

The total amount of boehmite and pseudoboehmite in the catalyst composition is generally about 1 wt % to about 50 wt %, preferably about 5 wt % to about 45 wt %, more preferably about 10 wt % to about 45 wt %, even more preferably about 15 wt % to about 45 wt %, relative to the total weight of the catalyst composition. This amount does not include alumina from the zeolite component or other sources.

The fluid cracking catalyst compositions can optionally contain other aluminum-containing components. Other aluminum-containing components, when present, include polyaluminum chlorides such as aluminum chlorohydrate, polyaluminum nitrates, and polyaluminum sulfates. Mixtures of two or more other aluminum-containing components of the same or different types can be used. In some embodiments in which one or more other aluminum-containing components are present, the combined amount of alumina and other aluminum-containing components is about 20 wt % or more, preferably about 30 wt % or more, more preferably about 50 wt % or more, relative to the total weight of the catalyst composition; these amounts do not include alumina from the zeolite component or other sources. In other embodiments in which one or more other aluminum-containing components are present, the combined amount of alumina and other aluminum-containing components is about 20 wt % to about 80 wt %, preferably about 30 wt % to about 80 wt %, more preferably about 50 wt % to about 80 wt %, relative to the total weight of the catalyst composition; these amounts do not include alumina from the zeolite component or other sources.

In the practice of this invention, in the fluid cracking catalyst compositions, the zeolites and alumina are present in a combined amount of about 25 wt % or more, preferably about 30 wt % or more, more preferably about 35 wt % or more, relative to the total weight of the catalyst composition. In some embodiments, the zeolites and alumina are present in a combined amount of about 25 wt % to about 90 wt %, preferably about 30 wt % to about 85 wt %, more preferably about 35 wt % to about 85 wt %, relative to the total weight of the catalyst composition. These amounts do not include alumina from the zeolite component or other sources.

The optional silica component in the fluid cracking catalyst compositions used in the processes of this invention can be one or more of an inorganic silicate, an organic silicate, (poly) silicic acid, an organochlorosilane, fumed silica, or colloidal silica. Inorganic silicates include ammonium silicate, lithium silicate, sodium silicate, potassium silicate, magnesium silicate, calcium silicate, strontium silicate, barium silicate, zinc silicate, and phosphorus silicate; mixtures of any two or more of these silicates can comprise the silica component. Suitable organic silicates are compounds containing Si—O—C—O—Si structures, in particular silicones, especially polyorganosiloxanes such as polymethylphenylsiloxane and polydimethylsiloxane. Organochlorosilanes include methyl chlorosilane, dimethyl chlorosilane, trimethyl chlorosilane, and mixtures thereof. The colloidal silicas preferably have an average particle size of about 1 nm to about 500 nm, more preferably, the colloidal silica has an average particle size of about 1.5 nm to about 100 nm, even more preferably about 1.5 nm to about 50 nm. Silica components in the practice of this invention preferably have a low sodium content (e.g., about 1.5 wt % or less). Preferred silica components include sodium-stabilized colloidal silica, ammonium-stabilized colloidal silica, acid-stabilized colloidal silica; mixtures of any two or all three of these types of stabilized colloidal silicas can be used.

The total amount of this silica component in the catalyst composition, when present, is generally about 0.1 wt % to about 20 wt %, preferably about 0.25 wt % to about 15 wt %, more preferably about 0.5 wt % to about 10 wt %, even more preferably about 1 wt % to about 7.5 wt %, relative to the total weight of the dry ingredients that form the catalyst composition. This amount does not include silica from the zeolite component or other sources, such as clays.

In some embodiments, the catalyst composition comprises both an alumina component and a silica component.

Optionally, one or more clays can be present in the catalyst composition. In some embodiments, one or more clays is present in the catalyst composition. Suitable clays for the catalyst composition include kaolin, bentonite, saponite, sepiolite, attapulgite, laponite, laolinite, hectorite, halloysite, montmorillonite, English clay, anionic clays such as hydrotalcite, and heat-treated or chemically treated clays such as meta-kaolin. Preferred clays include kaolin, bentonite, and hydrotalcite.

When present, the total amount of clay in the catalyst composition is generally about 0.1 wt % to about 75 wt %, preferably about 5 wt % to about 65 wt %, more preferably about 10 wt % to about 60 wt %, relative to the total weight of the catalyst composition.

For the fluid catalytic cracking catalyst compositions in which all of the components of the catalyst composition are present in a single particle, the ratio of zeolite surface area to matrix surface area can be determined. For purposes of determining the surface area ratio, the matrix includes the alumina, and, when present, silica and clay. In some embodiments in which all of the components of the catalyst composition are present in a single particle, the zeolite to matrix surface area ratio is about 5:1 or less, preferably about 2:1 or less, more preferably about 1.5:1 or less. In other embodiments in which all of the components of the catalyst composition are present in a single particle, the zeolite to matrix surface area ratios are typically about 1.5:1 or less, preferably about 1.3:1 or less. In another embodiment in which all of the components of the catalyst composition are present in a single particle, the zeolite to matrix surface area ratio is about 0.25:1 to about 1.5:1, preferably about 0.45:1 to about 1.5:1, more preferably about 0.45:1 to about 1.4:1. In still other embodiments in which all of the components of the catalyst composition are present in a single particle, the zeolite to matrix surface area ratio is about 1:1 or less. In yet other embodiments in which all of the components of the catalyst composition are present in a single particle, the zeolite to matrix surface area ratio is about 0.25:1 to about 1:1, preferably about 0.45:1 to about 1:1.

The fluid cracking catalyst compositions can be made in various ways. In some embodiments, the rare earth component is present in the Y-type zeolite; in other embodiments, the rare earth component is added separately from the Y-type zeolite. In some embodiments in which the fluid cracking catalyst compositions include a ZSM-5 zeolite, the phosphorus component is present in the ZSM-5 zeolite; in other embodiments, the phosphorus component is added separately from the ZSM-5 zeolite.

The feedstock in the processes of this invention comprise an oxygenated feed comprising at least one oxygenated compound and optionally a hydrocarbon feed. When a hydrocarbon feed is part of the feedstock, the oxygenated feed can be present in any amount, e.g., from about 0.1 wt % to about 99.9 wt % of the feedstock. In some embodiments, the oxygenated feed is about 0.5 wt % or more of the feedstock, usually about 0.5 wt % to about 60 wt % of the feedstock, preferably about 1 wt % to about 50 wt %, more preferably about 3 wt % to about 30 wt %, even more preferably about 3 wt % to about 20 wt %, still more preferably about 3 wt % to about 15 wt %, yet more preferably about 3 wt % to about 10 wt %, of the feedstock.

Another way of expressing the amount of oxygenated feed or oxygenated compound(s) present in the feedstock is as the amount of oxygen present in the feedstock. In terms of oxygen present in the feedstock, the amount of oxygen is about 0.01 wt % or more of the feedstock, usually about 0.01 wt % to about 50 wt % of the feedstock, preferably about 0.1 wt % to about 40 wt %, more preferably about 0.1 wt % to about 25 wt %, even more preferably about 0.1 wt % to about 15 wt %, still more preferably about 0.1 wt % to about 10 wt %, yet more preferably about 0.1 wt % to about 5 wt %, of the feedstock. Other preferred amounts of oxygen in the feedstock are about 0.1 wt % or more of the feedstock, usually about 0.1 wt % to about 12 wt % of the feedstock, preferably about 0.1 wt % to about 6 wt %, more preferably about 0.1 wt % to about 3 wt %, even more preferably about 0.1 wt % to about 2 wt %, still more preferably about 0.1 wt % to about 1.5 wt %, yet more preferably about 0.1 wt % to about 1 wt %, of the feedstock.

The oxygenated compounds used in the processes of this invention contain at least carbon, hydrogen, and oxygen, and have one or more carbon atoms, one or more hydrogen atoms, and one or more oxygen atoms. Compounds containing only one carbon atom can be used; compounds containing only one oxygen atom can be used. Usually, there are two or more than one hydrogen atoms present in the oxygenated compound; often there are more than two hydrogen atoms present.

Preferably, the oxygenated compound has an oxygen content of about 5 wt % or more, or about 5 wt % to about 75 wt %. More preferred are oxygenated compounds with a molecular weight of about 30 grams per mole or more and an oxygen content of about 5 wt % or more, preferably about 5 wt % to about 60 wt %.

Suitable oxygenated compounds include formaldehyde, methanol, ethanol, propanol, glycerol, polyols, phenolic compounds, furans, quinones, fatty acids, fatty acid methyl esters (FAME), triglycerides (including animal fats) such as soybean oil, palm oil, rapeseed oil (canola oil), other vegetable oils, other oils extracted from plants, distiller's corn oil, used cooking oil, and/or derivatives of any of these oxygenated compounds, where “derivatives” refers to products, co-products, or by-products from physical processing or chemical processing, or a combination thereof. Additional suitable oxygenated compounds include biogenic pyrolysis oils, waste-derived pyrolysis oils, hydrothermal liquid oils, sewage sludge-derived oils, plastic-derived oils, municipal waste-derived oils, or industrial waste-derived oils, and/or derivatives of any of these oxygenated compounds, where “derivatives” refers to products, co-products, or by-products from physical processing or chemical processing, or a combination thereof. Physical processing for these oxygenated compounds can include distillation, filtration, and/or oil pressing and/or filtration. Chemical processing for these oxygenated compounds can include removal of contaminants and/or conversion processes; conversion processes typically include fermentation, esterification, saponification, and metathesis. Mixtures of any two or more oxygenated compounds and/or derivatives thereof can be used. Preferred oxygenated compounds include triglycerides, more preferred are soybean oil, palm oil, rapeseed oil (canola oil), other vegetable oils, other oils extracted from plants, and used cooking oil.

In some embodiments, the oxygenated compounds occur as mixtures, especially those derived from biological sources or waste sources. Biological sources include biomass, pyrolysis oils, algae, agricultural wastes, animal wastes and fats, and tall oil. Carbon-based waste sources include municipal wastes, industrial wastes, sewage sludge, household waste, and electronic waste. Oxygenated mixtures derived from biological sources or waste sources are products, co-products, and/or by-products of physical or chemical processing of biological sources or waste sources, often thermochemical or catalytic conversion of the biological source or waste source. Typical processes which produce oxygenated mixtures include separations, such as distillation or extraction, various pyrolysis processes, gasification, hydrothermal liquefaction, torrefaction, polymerization, depolymerization, Fischer-Tropsch synthesis, and acid or base digestions. Combinations of one or more processes can be used to generate the oxygenated compounds or oxygenated mixtures. Oxygenated compounds and/or oxygenated mixtures obtained by further processing, extractions, or chemical or physical alterations of the products can also be used to generate oxygenated compounds or mixtures used in the process of this invention.

Additional oxygenated compounds that occur as mixtures and can be used in the process of this invention include aqueous phase liquids from pyrolysis of organic compounds or mixtures of organic compounds, and vapors from various processes such as pyrolysis, hydrothermal liquefaction, or gasification performed on organic compounds or mixtures of organic compounds.

Related substances that can be used in the oxygenated feed include pyrolysis oils that have been processed to reduce their oxygen and/or nitrogen content, and/or to remove metals and/or other contaminants. Some of these substances that occur as mixtures contain one or more heteroatoms (in addition to the oxygen), such as nitrogen or sulfur, but a large range of other heteroatoms may be present. Mixtures of these substances that occur as mixtures with each other and/or with one or more oxygenated compounds can be used in the practice of this invention.

When a hydrocarbon feed is part of the feedstock, the hydrocarbon feed can be a resid feed, light gas oil (LGO), heavy gas oil (HGO), vacuum gas oil (VGO), deep cut gas oil, thermal oil, cycle stock, whole top crude, tar sand oil, shale oil, synthetic fuel, naphtha, petroleum gas or liquefied petroleum gas (LPG), heavy hydrocarbon fractions such as those derived from the destructive hydrogenation of coal, tar, pitches, asphalts, and/or hydrotreated feeds derived from any of the foregoing.

The term “feedstock” as used throughout this document does not limit the physical form of the feeds (e.g., gas, liquid, suspension, slurry, emulsion). When a hydrocarbon feed and an oxygenated feed form the feedstock, there is no requirement for pre-mixing or a combined feed; these feeds can be introduced separately; the only requirement is that a portion of the hydrocarbon feed and a portion of the oxygenated feed are present in the reaction chamber with the fluid catalytic cracking catalyst composition at the same time in the desired ratio.

As used throughout this document, the phrase “oxygenated feed” refers to the feed comprising one or more oxygenated compounds. The oxygenated feed may form the entire feedstock, or may comprise part of the feedstock, with a hydrocarbon feed comprising another part of the feedstock.

The processes of this invention are generally considered to be fluid catalytic cracking processes. In an FCC process, the catalyst is generally a fine particulate with about 90 wt % or more of the particles having diameters in the range of about 5 to about 300 microns; in the FCC process, a hydrocarbon feed is gasified and directed upward through a reaction zone, such that the particulate catalyst is entrained and fluidized in the hydrocarbon feed stream, and the catalyst contacts the gaseous hydrocarbon feed, which is cracked by the catalyst.

In the processes of this invention, the feedstock is contacted with a fluid catalytic cracking composition at fluid catalytic cracking conditions to obtain a product. The catalyst to oil ratio is typically in the range of about 1 to about 15 (wt/wt). In some embodiments, the catalyst to oil ratio is typically in the range of about 2 to about 12 (wt/wt). Temperatures in the fluid cracking reaction zone are generally about 300° C. to about 700° C., often about 400° C. to about 650° C. In some embodiments, the reaction zone temperatures are in the range of about 450° C. to about 575° C. Pressures in the fluid cracking reaction zone are usually in the range of about 14 pounds per square inch to about 45 pounds per square inch (0.097 MPa to 0.31 MPa). In some embodiments, the pressure in the reaction zone is in the range of about 14.5 pounds per square inch to about 29.4 pounds per square inch (0.1 MPa to 0.2 MPa). In other embodiments, the pressure in the reaction zone is atmospheric pressure. Contact times for the feedstock and fluid catalytic cracking catalyst composition typically range from about 0.5 second to about 10 seconds. In some embodiments, the contact time ranges from about 1 second to about 5 seconds. In other embodiments, the contact time ranges from about 1 second to about 3 seconds. Reaction outlet temperatures in the processes of this invention are generally about 400° C. to about 650° C. In some embodiments, the reaction zone temperature ranges from about 450° C. to about 600° C. In other embodiments, the reaction zone temperature ranges from about 500° C. to about 575° C.

The processes of this invention comprise contacting a fluid cracking catalyst composition, with a feedstock comprising at least one oxygenated compound and optionally a hydrocarbon feed. In some embodiments, the fluid cracking catalyst composition contains one or more Y-type zeolites, one or more ZSM-5 zeolites, a rare earth component, a phosphorus component, and alumina comprising boehmite and/or pseudoboehmite. In other embodiments, the fluid cracking catalyst composition contains one or more Y-type zeolites, a rare earth component, a phosphorus component, and alumina comprising boehmite and/or pseudoboehmite.

Another embodiment of this invention is a fluid cracking catalyst composition comprising one or more Y-type zeolites, one or more ZSM-5 zeolites, a rare earth component, a phosphorus component, and alumina comprising boehmite and/or pseudoboehmite. The features of these components, the amounts thereof, and preferences for all of these are as described above.

Still another embodiment of this invention is a fluid cracking catalyst composition comprising one or more Y-type zeolites, a rare earth component, a phosphorus component, and alumina comprising boehmite and/or pseudoboehmite. The features of these components, the amounts thereof, and preferences for all of these and preferences therefor are as described above.

The following examples are presented for purposes of illustration, and are not intended to impose limitations on the scope of this invention.

### Example 1

Various feedstocks were subjected to fluid catalytic cracking using various fluid catalytic cracking catalysts, one in admixture with 15 to 19.5 wt % ZSM-5. For the catalysts containing phosphorus, the phosphorus was introduced as an aqueous solution of H₃PO₄.

Catalysts C, E, and A are comparative. Catalyst C contained 25 to 35 wt % Y zeolite; 25 to 35 wt % alumina (boehmite and/or pseudoboehmite); 1 to 3 wt % silica; 0.2 to 2 wt % rare earth as lanthanum oxide (La₂O₃) present in the Y zeolite, with the remainder being a mineral clay; this catalyst had a fresh surface area between 200 m²/g and 300 m²/g and a zeolite to matrix surface area between 0.5:1 and 1.5:1. Catalyst E contained 25 to 35 wt % Y zeolite; 25 to 35 wt % alumina (boehmite and/or pseudoboehmite); 1 to 3 wt % silica; 0.2 to 2 wt % rare earth as lanthanum oxide present in the Y zeolite, 0.2 to 2 wt % phosphorus as P₂O₅, with the remainder being a mineral clay; this catalyst had a fresh surface area between 275 m²/g and 350 m²/g and a zeolite to matrix surface area between 0.5:1 and 1.5:1. Catalyst A contained 2.5 to 5 wt % ZSM-5; 15 to 25 wt % Y zeolite; 25 to 35 wt % alumina (boehmite and/or pseudoboehmite); 1.5 to 5 wt % silica; 1 to 3 wt % rare earth as lanthanum oxide present in the Y zeolite, with the remainder being a mineral clay; this catalyst had a fresh surface area between 200 m²/g and 300 m²/g and a zeolite to matrix surface area between 1:1 and 1.7:1. The amounts of the components in Catalysts C, E, and A are listed in Table 1A.

Catalysts D, F, and B are inventive. Catalyst D contained 5 to 10 wt % ZSM-5; 25 to 35 wt % Y zeolite; 25 to 35 wt % alumina (boehmite and/or pseudoboehmite); 1 to 3 wt % silica; 1.5 to 3.5 wt % rare earth as La₂O₃ present in the Y zeolite, with the remainder being a mineral clay; this catalyst had a zeolite to matrix surface area between 0.5:1 and 1.3:1. Catalyst F contained 5 to 10 wt % ZSM-5; 25 to 35 wt % Y zeolite; 25 to 35 wt % alumina (boehmite and/or pseudoboehmite); 1 to 3 wt % silica; 1.5 to 3.5 wt % rare earth as La₂O₃ present in the Y zeolite, 0.2 to 2 wt % phosphorus as P₂O₅, with the remainder being a mineral clay; this catalyst had a zeolite to matrix surface area between 0.5:1 and 1.2:1. Catalyst B contained a mixture of a) 70 wt % of a catalyst containing 2.5 to 5 wt % ZSM-5; 15 to 35 wt % Y zeolite; 20 to 35 wt % alumina (boehmite and/or pseudoboehmite); 1.5 to 5 wt % silica; 1.3 wt % rare earth as lanthanum oxide present in the Y zeolite, with the remainder being a mineral clay, and b) 30 wt % of an additive containing 50 to 75 wt % ZSM-5, 2 to 20 wt % alumina (boehmite and/or pseudoboehmite), 2 to 10 wt % silica, and 2 to 15 wt % phosphorus as P₂O₅. Catalyst B was prepared by physical mixing of the part a) and part b) powders. The amounts of the components in Catalysts D, F, and B are listed in Table 1B.

Catalysts A-F were subjected to Advanced Cracking Evaluation Technology (ACE Technology®; Kayser Technology, Inc.) with feedstocks of varying ratios of soybean oil and VGO. The hydrocarbon feed was a vacuum gas oil (VGO) feed and the oxygenated feed was a refined, bleached, degummed, deodorized soybean oil containing about 8 wt % to about 11 wt % oxygen. The feedstock had amounts of VGO ranging from 0 to 100 wt %, and soybean oil ranging from 0 to 100 wt %. When both soybean oil and VGO were present in the feedstock, the soybean oil and the VGO were mixed together and fed as a single stream. The catalyst-to-oil ratio (CTO), calculated as the total weight of the total catalyst divided by the total weight of feed oil introduced to the reactor for a given run. CTO ratios were varied between 2 and 10 grams-catalyst/gram-feed. Testing was performed in the ACE Technology® unit in accordance with ASTM D7964/D7964M-19 (Standard Test Method for Determining Activity of Fluid Catalytic Cracking (FCC) Catalysts in a Fluidized Bed). The temperature in the reaction zone was 480° C. to 540° C., and the reaction zone pressure was 14.5 psia to 25 psia (0.1 MPa to 0.17 MPa). Characteristics of the VGO feed are listed in Table 2. Relative amounts of soybean oil and VGO, and the results of the ACE Technology® testing are summarized in Tables 3A-3B and 4A-4B.

TABLE 1A

| | Catalyst | | Catalyst | | Catalyst | |
|---|---|---|---|---|---|---|
| Component | C¹ | | E¹ | | A¹ | |
| ZSM-5 | 0 | | 0 | | 2.5 to 5 | wt % |
| Y zeolite | 25 to 35 | wt % | 25 to 35 | wt % | 15 to 25 | wt % |
| alumina | 25 to 35 | wt % | 25 to 35 | wt % | 25 to 35 | wt % |
| silica | 1 to 3 | wt % | 1 to 3 | wt % | 1.5 to 5 | wt % |
| rare earth oxide | 0.2 to 2 | wt % | 0.2 to 2 | wt % | 1 to 3 | wt % |

| | | | | |
|---|---|---|---|---|
| P (as P₂O₅) | 0 | 0.2 to 2 | wt % | 0 |

| | | | |
|---|---|---|---|
| mineral clay | remainder | remainder | remainder |
| surface area ratio² | 0.5:1 to 1.5:1 | 0.5:1 to 1.5:1 | 1:1 to 1.7:1 |

¹Catalysts C, E, and A are comparative.
²Ratio of total zeolites: matrix, where the matrix is alumina + silica + clay.

TABLE 1B

| | Catalyst | | Catalyst | | Catalyst | |
|---|---|---|---|---|---|---|
| Component | D | | F | | B | |
| ZSM-5 | 5 to 10 | wt % | 5 to 10 | wt % | 16.75 to 25.1 | wt % |
| Y zeolite | 25 to 35 | wt % | 25 to 35 | wt % | 10.5 to 17.5 | wt % |
| alumina | 25 to 35 | wt % | 25 to 35 | wt % | 18.1 to 30.5 | wt % |
| silica | 1 to 3 | wt % | 1 to 3 | wt % | 1.65 to 6.5 | wt % |
| rare earth | 1.5 to 3.5 | wt % | 1.5 to 3.5 | wt % | 0.7 to 2.1 | wt % |
| oxide | | | | | | |

| | | | | | |
|---|---|---|---|---|---|
| P (as P₂O₅) | 0 | 0.2 to 2 | wt % | 0.6 to 4.5 | wt % |

| | | | |
|---|---|---|---|
| mineral clay | remainder | remainder | remainder |
| surface area | 0.5:1 to 1.3:1 | 0.5:1 to 1.2:1 | — |
| ratio¹ | | | |

¹Ratio of total zeolites: matrix, where the matrix is alumina + silica + clay.

TABLE 2

| | | | Distillation | |
|---|---|---|---|---|
| Component | Amount | | properties | |
| API gravity | 24.1 | | Initial | 410° F. |
| | | | boiling | (210° C.) |
| | | | pt. (IBP) | |
| Total sulfur | 0.20 | wt % | 5 wt % | 555 |
| Total nitrogen | 1030 | ppm | 10 wt % | 609 |
| Basic nitrogen | 179 | ppm | 20 wt % | 674 |
| Conradson carbon | 0.39 | wt % | 30 wt % | 719 |

| | | | |
|---|---|---|---|
| Aniline point | 182° F. | 40 wt % | 759 |
| | (83.3°° C.) | | |
| Ni | trace | 50 wt % | 797 |
| V | trace | 60 wt % | 835 |
| | | 70 wt % | 877 |
| | | 80 wt % | 930 |
| | | 90 wt % | 1017 |
| | | 95 wt % | 1115 |
| | | Endpoint | 1273° F. |
| | | temp. (EP) | (689.4° C.) |

TABLE 3A

| Run* | 1 | 2 | 3 | 4 | 5 | 6 |
|---|---|---|---|---|---|---|
| Catalyst | A | A | A | A | A | A |
| VGO, wt % | 100 | 95 | 95 | 80 | 50 | 0 |
| Soybean oil, wt % | 0 | 5 | 5 | 20 | 50 | 100 |
| Oxygen in feed, wt % | 0 | 0.4 | 0.4 | 1.7 | 4.2 | 8.3 |
| Catalyst-to-Oil | 4 | 4 | 3 | 4 | 4 | 4 |
| Conversion, wt % | 66.0 | 66.9 | 63.7 | 68.0 | 72.5 | 74.6 |
| Dry Gas, wt % | 3.1 | 3.0 | 2.9 | 3.0 | 3.2 | 3.3 |
| Hydrogen, wt % | 0.4 | 0.3 | 0.4 | 0.3 | 0.2 | 0.2 |
| CH₄, wt % | 1.1 | 1.0 | 1.0 | 1.0 | 1.1 | 1.0 |
| Ethylene + ethane, wt % | 1.5 | 1.5 | 1.5 | 1.6 | 1.8 | 2.1 |
| LPG, wt % | 20.0 | 20.0 | 19.5 | 19.8 | 20.3 | 19.9 |
| Gasoline, wt % | 36.8 | 37.5 | 36.0 | 38.8 | 41.7 | 42.6 |
| LCO, wt % | 20.7 | 19.6 | 20.6 | 19.2 | 17.5 | 15.7 |
| Slurry, wt % | 13.3 | 12.8 | 15.1 | 12.1 | 8.5 | 4.1 |
| Coke, wt % | 6.1 | 5.9 | 5.0 | 5.9 | 6.1 | 6.4 |
| (C₃═ + C₄═'s)/LPG, wt % | 0.776 | 0.780 | 0.785 | 0.779 | 0.792 | 0.809 |
| CO + CO₂, wt % | 0.00 | 0.51 | 0.33 | 0.50 | 1.22 | 2.21 |

*All runs with Catalyst A are comparative.

TABLE 3B

| Run* | 7 | 8 | 9 | 10 | 11 | 12 |
|---|---|---|---|---|---|---|
| Catalyst | C | C | C | E | E | E |
| VGO, wt % | 100 | 95 | 80 | 100 | 95 | 80 |
| Soybean oil, wt % | 0 | 5 | 20 | 0 | 5 | 20 |
| Oxygen in feed, wt % | 0 | 0.5 | 2.1 | 0 | 0.5 | 2.1 |
| Catalyst-to-Oil | 3 | 3 | 3 | 3 | 4 | 3 |
| Conversion, wt % | 73.3 | 73.5 | 73.7 | 67.2 | 68.5 | 70.6 |
| Dry Gas, wt % | 2.1 | 2.7 | 2.3 | 2.2 | 2.1 | 2.2 |
| Hydrogen, wt % | 0.3 | 0.3 | 0.2 | 0.4 | 0.3 | 0.2 |
| CH₄, wt % | 0.8 | 1.0 | 0.9 | 0.7 | 0.7 | 0.8 |
| Ethylene + ethane, wt % | 1.0 | 1.4 | 1.3 | 1.1 | 1.0 | 1.2 |
| LPG, wt % | 11.9 | 19.7 | 16.0 | 14.9 | 14.6 | 15.7 |
| Gasoline, wt % | 55.5 | 46.8 | 50.5 | 48.8 | 48.8 | 48.9 |
| LCO, wt % | 18.4 | 17.7 | 17.3 | 20.3 | 19.6 | 19.1 |
| Slurry, wt % | 8.3 | 8.8 | 9.0 | 12.5 | 11.9 | 10.3 |
| Coke, wt % | 3.5 | 3.3 | 3.4 | 1.1 | 2.7 | 3.1 |
| (C₃═ + C₄═'s)/LPG, wt % | 0.7 | 0.7 | 0.7 | 0.7 | 0.7 | 0.7 |
| CO + CO₂, wt % | — | 1.0 | 1.5 | — | 0.3 | 0.7 |

*All runs with Catalyst C or E are comparative.

TABLE 4A

| Run | 13* | 14* | 15 | 16 | 17* | 18* | 19 | 20 |
|---|---|---|---|---|---|---|---|---|
| Catalyst | D | D | D | D | F | F | F | F |
| VGO, wt % | 100 | 100 | 95 | 80 | 100 | 100 | 95 | 80 |
| Soybean oil, wt % | 0 | 0 | 5 | 20 | 0 | 0 | 5 | 20 |
| Oxygen in feed, wt % | 0 | 0 | 0.5 | 2.1 | 0 | 0 | 0.5 | 2.1 |
| Catalyst-to-Oil | 3 | | 3 | 3 | 3 | 5 | 3 | 3 |
| Conversion, wt % | 69.0 | 74.5 | 70.8 | 73.4 | 63.9 | 71.7 | 65.2 | 68.6 |
| Dry Gas, wt % | 2.2 | 2.8 | 2.2 | 2.5 | 1.9 | 2.6 | 1.9 | 2.2 |
| Hydrogen, wt % | 0.3 | 0.4 | 0.3 | 0.2 | 0.3 | 0.4 | 0.2 | 0.1 |
| CH₄, wt % | 0.7 | 1.0 | 0.8 | 0.9 | 0.7 | 1.0 | 0.7 | 0.8 |
| Ethylene + ethane, wt % | 1.1 | 1.4 | 1.2 | 1.4 | 1.0 | 1.3 | 1.0 | 1.2 |
| LPG, wt % | 15.9 | 18.5 | 17.3 | 18.7 | 16.0 | 19.8 | 16.2 | 17.7 |
| Gasoline, wt % | 48.4 | 49.6 | 48.8 | 49.0 | 41.9 | 43.9 | 43.3 | 43.7 |
| LCO, wt % | 19.5 | 16.9 | 18.5 | 17.5 | 20.8 | 17.7 | 20.3 | 19.1 |
| Slurry, wt % | 11.5 | 8.5 | 10.7 | 9.1 | 15.3 | 10.6 | 14.4 | 12.3 |
| Coke, wt % | 2.1 | 3.4 | 2.1 | 2.4 | 2.7 | 4.1 | 2.7 | 3.1 |
| (C₃═ + C₄═'s)/LPG, wt % | 0.7 | 0.6 | 0.7 | 0.7 | 0.8 | 0.7 | 0.8 | 0.8 |
| CO + CO₂, wt % | — | 0.3 | 0.4 | 0.8 | — | — | 1.2 | 1.9 |

*Runs 13-14 and 17-18 are comparative.

TABLE 4B

| Run* | 21* | 22 | 23 | 24 | 25 | 26 |
|---|---|---|---|---|---|---|
| Catalyst | B | B | B | B | B | B |
| VGO, wt % | 100 | 95 | 90 | 80 | 50 | 0 |
| Soybean oil, wt % | 0 | 5 | 10 | 20 | 50 | 100 |
| Oxygen in feed, wt % | 0 | 0.4 | 0.8 | 1.7 | 4.2 | 8.3 |
| Catalyst-to-Oil | 4 | 4 | 4 | 4 | 4 | 4 |
| Conversion, wt % | 72.5 | 71.0 | 72.2 | 72.8 | 76.4 | 81.0 |
| Dry Gas, wt % | 5.3 | 5.1 | 5.2 | 5.2 | 5.3 | 5.3 |
| Hydrogen, wt % | 0.3 | 0.2 | 0.2 | 0.1 | 0.1 | 0.1 |
| CH₄, wt % | 1.0 | 0.9 | 0.9 | 0.8 | 0.8 | 0.7 |
| Ethylene + ethane, wt % | 3.9 | 3.9 | 4.1 | 4.2 | 4.3 | 4.4 |
| LPG, wt % | 30.8 | 30.6 | 31.1 | 31.2 | 30.6 | 30.0 |
| Gasoline, wt % | 30.3 | 30.0 | 30.8 | 31.3 | 34.5 | 38.5 |
| LCO, wt % | 17.0 | 16.7 | 16.5 | 16.1 | 14.1 | 10.5 |
| Slurry, wt % | 10.6 | 11.6 | 10.8 | 10.5 | 7.8 | 3.3 |
| Coke, wt % | 6.1 | 4.6 | 4.6 | 4.6 | 4.7 | 4.9 |
| (C₃═ + C₄═'s)/LPG, wt % | 0.696 | 0.717 | 0.721 | 0.730 | 0.764 | 0.816 |
| CO + CO₂, wt % | 0.00 | 0.57 | 0.44 | 0.52 | 1.40 | 2.37 |

*Run 21 is comparative.

In the runs above, a nearly 1 wt % coke reduction was achieved at low catalyst to oil ratios (e.g., about 3:1 by weight) for Catalyst B as compared to Catalyst A. When the fluid cracking catalyst composition contains about 15 wt % or more of ZSM-5 zeolite, a net coke reduction of about 1.5 wt % was relatively consistently observed for the various catalyst to oil ratios evaluated and for all ratios of oxygenated feed tested.

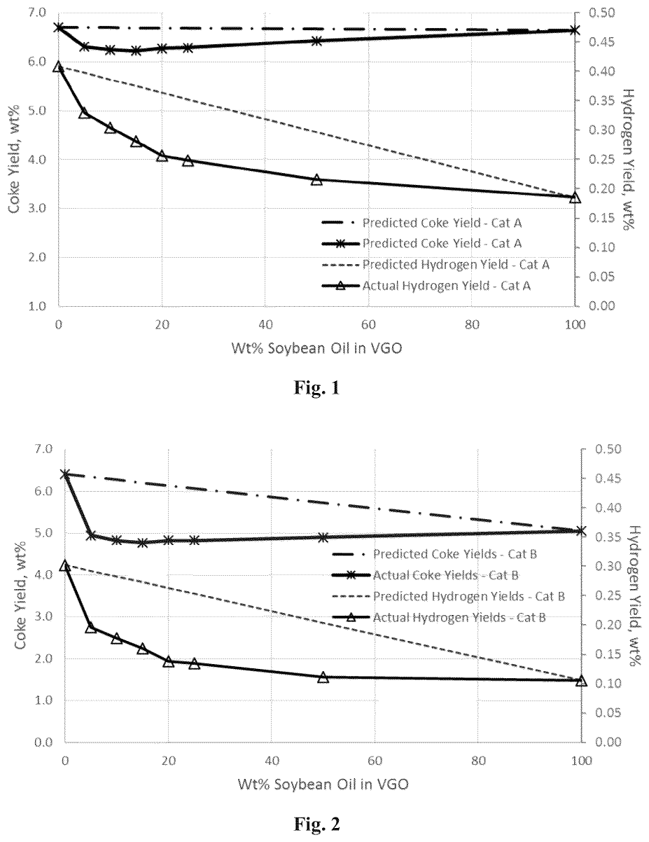

In FIG. 1, actual hydrogen and coke yields for comparative Catalyst A of Example 1 at varying ratios of soybean oil to VGO at a constant catalyst-to-oil ratio of 4 are compared to predicted hydrogen and coke yields. In FIG. 2, actual hydrogen and coke yields for Catalyst B of Example 1 at varying ratios of soybean oil to VGO at a constant catalyst-to-oil ratio of 4 are compared to predicted hydrogen and coke yields. For both FIG. 1 and FIG. 2, the predicted yields were calculated from the linear combination of the contributions to the yields of coke and hydrogen that would be obtained from processing VGO alone and from processing soybean oil alone. In equation form, the predicted yield calculation is expressed as follows, where SBO is soybean oil, and X is either hydrogen or coke.

$$Predicted yield of X , wt \% = {( Yield of X , wt \% )}_{100 \% VGO} * ( wt \% VGO in feed ) + {( Yield of X , wt \% )}_{100 \% SBO} * ( wt \% SBO in feed )$$

The actual yields are lower than what is predicted from additive effects or dilution effects of the feedstock for the yields of both coke and hydrogen, which demonstrates a synergetic effect of the feedstocks containing both VGO and an oxygenated compound (here, soybean oil) when cracking over either catalyst. For Catalyst B, the greater reduction in both coke and hydrogen yields demonstrates that the larger amount of the pentasil zeolite component (the phosphorus-containing ZSM-5 zeolite) as part of the Catalyst B fluid cracking catalyst composition improves the reduction in the amounts of coke and hydrogen made.

In addition to the observed reduction in coke and hydrogen, other improvements in the amounts of products obtained from fluid catalytic cracking processes according to the present invention include: bottoms reduction, reduction in dry gas volume at similar mass yields of dry gas, improvement in gasoline yield, propylene yield, and/or C₄ olefins yield, can be obtained with higher proportions of oxygenated components (about 2.5 wt % or more oxygen in the feedstock) when a small or medium pore zeolite, especially a pentasil zeolite, usually ZSM-5, often a phosphorus-containing ZSM-5 zeolite, is present in the fluid cracking catalyst composition in an amount of about 15 wt % or more. Another improvement in the amounts of products obtained when a pentasil zeolite additive, usually ZSM-5, often a phosphorus-containing ZSM-5 zeolite, is present with the fluid cracking catalyst composition in an amount of about 15 wt % or more and oxygenated components providing about 2.5 wt % or more oxygen in the feedstock is increased olefinicity of liquid petroleum gas (LPG) due to the increase in the formation of product components such as propylene and butylenes without increasing the amount of LPG made. Still another improvement obtained when a small or medium pore zeolite, especially a pentasil zeolite, usually ZSM-5, often a phosphorus-containing ZSM-5 zeolite, is present in the fluid cracking catalyst composition in an amount of about 15 wt % or more, is an even greater reduction in the volume of dry gas produced.

The invention permits the use of hydrocarbon feedstocks without reduction of the carbon residues therein or reduction of the amount of metal contamination therein.

Presence of the oxygenated component allows the FCC process to be operated at higher conversions and catalyst to oil ratios, and at higher throughputs than otherwise attainable. The reduction in hydrogen formation allows operation at higher (catalyst) temperatures to increase product throughput and/or conversion levels, while producing more liquefied petroleum gas (LPG) and LPG range olefins.

Reduction in dry gas volume formation in turn permits wet gas compressor limitations to be reduced, which allows for greater light olefin production or higher unit throughput.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A process for fluid catalytic cracking of a feedstock, which process comprises contacting a fluid catalytic cracking catalyst composition with a feedstock comprising an oxygenated feed and optionally a hydrocarbon feed, wherein the oxygenated feed comprises at least one oxygenated compound containing at least carbon, hydrogen, and oxygen, and wherein the fluid catalytic cracking catalyst composition comprises:
a) one or more Y-type zeolites, one or more ZSM-5 zeolites, a rare earth component, and alumina comprising boehmite and/or pseudoboehmite, or
b) one or more Y-type zeolites, a rare earth component, and alumina comprising boehmite and/or pseudoboehmite.

2. (canceled)

3. A process as in claim 1 wherein in a):
the Y-type zeolite is in an amount of about 0.5 wt % or more;
the ZSM-5 zeolite is in an amount of about 1 wt % or more; and/or
the rare earth component is in an amount of about 0.25 wt % or more as its rare earth oxide(s),
wherein the amounts are relative to the total weight of the catalyst composition.

4. (canceled)

5. A process as in claim 1 wherein in b):
the Y-type zeolite is in an amount of about 5 wt % or more; and/or
the rare earth component is in an amount of about 0.25 wt % or more as its rare earth oxide(s),
wherein the amounts are relative to the total weight of the catalyst composition.

6. (canceled)

7. A process as in claim 1 wherein the alumina is boehmite and/or pseudoboehmite, and wherein the alumina is in an amount of 0.1 to 50 wt % relative to the total weight of the catalyst composition.

8. A process as in claim 1 wherein the zeolites and alumina are in a combined amount of about 25 wt % or more relative to the total weight of the catalyst composition.

9. (canceled)

10. (canceled)

11. (canceled)

12. A process as in claim 1 wherein the oxygenated feed is comprised of one oxygenated compound that has an oxygen content of about 5 wt % or more.

13. (canceled)

14. A process as in claim 1 wherein the oxygenated compound is soybean oil.

15. A process as in claim 1 wherein the feedstock includes a hydrocarbon feed, and wherein the oxygenated feed is about 0.5 wt % or more of the feedstock.

16. (canceled)

17. A fluid catalytic cracking catalyst composition which comprises
a) one or more Y-type zeolites, one or more ZSM-5 zeolites, a rare earth component, and alumina comprising boehmite and/or pseudoboehmite, or
b) one or more Y-type zeolites, a rare earth component, and alumina comprising boehmite and/or pseudoboehmite.

18. A composition as in claim 17 wherein the Y-type zeolite is Y zeolite or ultrastable Y zeolite.

19. A composition as in claim 17 wherein in a):
the Y-type zeolite is in an amount of about 0.5 wt % or more;
the ZSM-5 zeolite is in an amount of about 1 wt % or more; and/or
the rare earth component is in an amount of about 0.25 wt % or more as its rare earth oxide(s),
wherein the amounts are relative to the total weight of the catalyst composition.

20. A composition as in claim 17 wherein in a), the zeolites are in a weight ratio of Y-type zeolite to ZSM-5 zeolite of about 0.25:1 or more.

21. A composition as in claim 17 wherein in b):
the Y-type zeolite is in an amount of about 5 wt % or more; and/or
the rare earth component is in an amount of about 0.25 wt % or more as its rare earth oxide(s),
wherein the amounts are relative to the total weight of the catalyst composition.

22. A composition as in claim 17 wherein the rare earth component comprises yttrium, lanthanum, cerium, and/or praseodymium.

23. A composition as in claim 17 wherein the alumina is boehmite or boehmite and pseudoboehmite, and/or wherein the alumina is in an amount of 0.1 to 50 wt % relative to the total weight of the catalyst composition.

24. A composition as in claim 17 wherein the zeolites and alumina are in a combined amount of about 25 wt % or more relative to the total weight of the catalyst composition.

25. A composition as in claim 17 wherein silica is present, and wherein the silica is in an amount of about 0.1 wt % to about 20 wt % relative to the total weight of the catalyst composition.

26. A composition as in claim 17 wherein a clay is present, and wherein the clay is in an amount of about 0.1 wt % to about 75 wt % relative to the total weight of the catalyst composition.

27. A composition as in claim 17 wherein a phosphorus component is present, and wherein the phosphorus component is in an amount of about 0.1 wt % or more as phosphorus pentoxide relative to the total weight of the catalyst composition.
